(19) United States
(12) Patent Application Publication
(10) Pub. No.: US 2026/0212738 A1
(43) Pub. Date: Jul. 23, 2026

(54) Item Locator and Personal Protection Device

(71) Applicant: Eddie Watkins, Forest Park, IL (US)

(72) Inventor: Eddie Watkins, Forest Park, IL (US)

(21) Appl. No.: 19/030,301

(22) Filed: Jan. 17, 2025

(51) Int. Cl. G08B 3/10; G08B 21/24; G08B 25/01; H04R 1/32

(52) U.S. Cl. CPC G08B 3/10; G08B 21/24; G08B 25/016; H04R 1/323

(57) ABSTRACT

The item locator and personal protection device includes a locator chip comprising a panic button configured to trigger an emergency dispatch and a 360 degree speaker to emit a locator/self defense sound. The disclosure also includes a remote control configured to receive the locator chip and a visual recording lens and a microphone. The disclosure further includes an electronics configured to determine a separation distance between the locator chip and the remote control and to determine a time date stamp.

### BACKGROUND

There’s nothing worse than the thought of getting caught in an emergency whether it’s danger from falls, work related or domestic accidents, medical emergencies or violence related. Even with current modern technology advancements, there lacks an instant communicative device that can possibly remedy emergencies and violence. There have been no products available as original equipment or as an aftermarket to address this problem.

### SUMMARY OF THE INVENTION

The item locator and personal protection device includes a locator chip comprising a panic button configured to trigger an emergency dispatch and a 360 degree speaker to emit a locator/self defense sound. The disclosure also includes a remote control configured to receive the locator chip and a visual recording lens and a microphone. The disclosure further includes an electronics configured to determine a separation distance between the locator chip and the remote control and to determine a time date stamp.

### BRIEF DESCRIPTION OF THE DRAWINGS

FIG. 1 is a top perspective view of a remote control for the item locator and personal protection device in accordance with an embodiment of the present disclosure.

FIG. 2 is a top perspective view of a detachable chip for the item locator and personal protection device in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

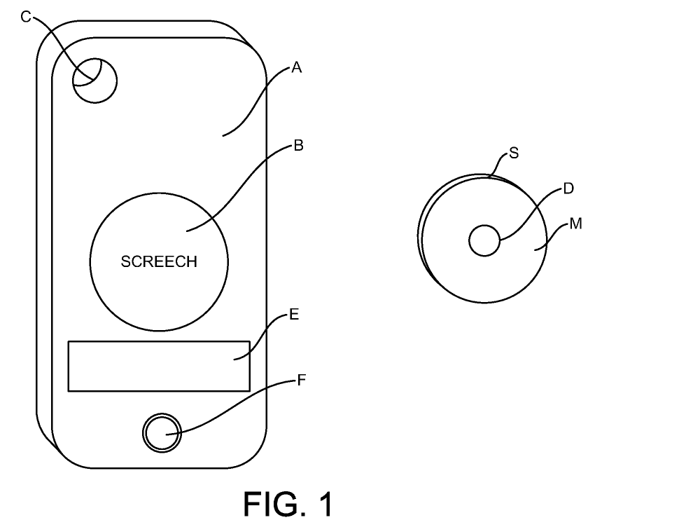

FIG. 1 is a top perspective view of the remote control for the Item locator and Personal Protection device in accordance with an embodiment of the present disclosure. The view includes the wearable remote control A, the panic button B paired with the electronics of the remote control A via Bluetooth, GPS, WIFI & Infrared and the keychain hole C defined in the remote control A. The electronics E of the remote control A include an internal day and time circuit and a visual and an audio recording lens and microphone F triggered by the depression of the panic button.

FIG. 2 is a top perspective view of the detachable chip for the Item Locator and Personal Protection device in accordance with an embodiment of the present disclosure. The view includes the detachable chip M, the Dispatch button D configured to transmit a time stamped recorded audio and video to 911 emergency dispatchers and to trigger a piercing audio sound via a 360 degree speaker S. The chip M is detachable as a personal protection upgrade to the item locator aspect of the disclosure. The chip M is detected by the remote control A to enable both the item locator and the personal protection electronics in the disclosure.

The present disclosure offers a modern accessory that serves to locate lost personal items and also create peace of mind as it prevents and/or curbs the success of abductions and accidents, and that victims of violence get help and/or attention sooner than later. The disclosure introduces a novel device that comes in the form of a key chain FOB, necklace or personally worn device possessing a discreet panic button. The panic button will be used when a user is in danger, and with advanced technology, will immediately contact the police in severe situations for assistance. To further enhance functionality, the device will have a tracker and a voice recording feature using Wi-Fi and Bluetooth to communicate with a paired cellular device to expedite contact and media sharing, as needed.

The main purpose of the Screacher is to provide a comprehensive tech-supported accessory for locating and protecting valuable items. Many individuals are fully aware of the common problem of losing or misplacing daily items such as keys, wallets, and phones, along with consideration for moments when a person may forget where they parked their vehicle. The frequency of these occurrences can be a challenge to manage, and in some cases, the lack of knowing where essential items are can lead to dangerous situations. Ingenious and practical, the Screacher offers a modern versatile tracking system that simplifies how any item of significance can be managed and precisely located with great ease while additionally serving as a personal protection device. As a locator, programmed to work with two complementing parts: a stick-on computer chip and a mobile app / remote control system, the Screacher is capable of emitting sound to aid in locating any item the chip is imposed on. A broadcast mode triggers an emergency dispatch signal to all locator chips in a predetermined proximity to the remote control.

Versatile in its applications, the chip and connecting receiver allows a person to program the device to 'screech" at varying decimals when users are within a certain distance from an item, further aiding in retrieval. As a personal protection device, an individual can simply press a button on the chip or a handheld remote, to immediately release a piercing audio alert communicating to others in proximity and potentially deterring threats during active emergencies. Designed for ease of use, this tracking accessory also possesses the ability to monitor unauthorized movement or tampering with belongings associated with the Screacher; thereby, providing enhanced security and proactive means to warn off the potential theft or loss of valuable items. Overall, the Screacher is intended to provide peace of mind to diverse users as it improves how valuable items can be managed using present technologies. As a result, this product may prove to be essential in the novelty/safety industry.

The disclosed product immediately locates your keys, your wallet, your phone, or anything that you can lose or misplace and can't locate, and even if someone steals an item from you. The disclosure works by way of a stick on computer chip, which is activated by an APP to lower the sound or amplify the sound to locate your item. Also embodiments of the chip include technology for Lojack Tracking Technology TM stuck on or attached by way of clip or pin to any item you don't want to lose. The disclosure is activated when you are 1- 2 feet or more away from the item, and can also be used as a protective device with the press of a button on it to immediately sound a screeching audible alarm.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A personal locator device comprising: a locator chip comprising a panic button configured to trigger an emergency dispatch and a 360 degree speaker to emit a locator/self defense sound; a remote control configured to receive the locator chip and a visual recording lens and a microphone; and an electronics configured to determine a separation distance between the locator chip and the remote control and to determine a time date stamp.

2. The personal locator device of claim 1, wherein the remote control defines a keychain hole therein also adaptable to a necklace.

3. The personal locator device of claim 1, wherein the locator chip comprises an adhesive for attachment to a personal item and attachment to the remote control.

4. The personal locator device of claim 1, wherein the locator/self defense sound comprises a frequency in an upper spectrum of human hearing.

5. The personal locator device of claim 1, wherein the locator/self defense sound comprises an amplitude less than a damaging decibels of human hearing.

6. The personal locator device of claim 1, wherein the separation distance determined to be less than two feet triggers the panic button of the locator chip.

7. The personal locator device of claim 1, wherein the separation distance determined to be less than a preset limit will create a higher frequency pulse.

8. The personal locator device of claim 1, wherein the separation distance determined to be greater than a preset limit created a lower frequency pulse.

9. The personal locator device of claim 1, wherein the emergency dispatch is time stamped by the electronics and transmitted to a law enforcement agency including 911.

10. The personal locator device of claim 1, wherein the electronics attaches a flag to the emergency dispatch to indicate the device has been stolen.

11. The personal locator device of claim 1, wherein the emergency dispatch is communicated to others in proximity via a preset condition.

12. The personal locator device of claim 1, further comprising a broadcast mode configured to trigger the emergency dispatch of multiple locator chips in a predetermined proximity.

13. The personal locator device of claim 1, further comprising a mobile application code and state machine logic to determine the separation distance and the emergency dispatch.

14. The personal locator device of claim 1, wherein the remote control is a cellular phone and the electronics is implemented via a mobile phone application.

15. The personal locator device of claim 1, wherein the remote control is configured to deactivate a locator chip.
